(19) United States
(12) Patent Application Publication
(10) Pub. No.: US 2018/0173228 A1
(43) Pub. Date: Jun. 21, 2018

(54) VEHICLE CONTROL DEVICE

(71) Applicant: HONDA MOTOR CO., LTD., Tokyo (JP)

(72) Inventors: Koichiro Wada, Wako-shi (JP); Yoshihiro Mori, Wako-shi (JP); Shinya Shirokura, Wako-shi (JP)

(21) Appl. No.: 15/840,081

(22) Filed: Dec. 13, 2017

(30) Foreign Application Priority Data
Dec. 19, 2016 (JP) 2016-245333

(51) Int. Cl. G05D 1/00

(52) U.S. Cl. CPC G05D 1/0061; G05D 1/0088

(57) ABSTRACT

A vehicle control device includes a travel control processing unit configured to control traveling of a host vehicle in accordance with either one of an automated driving mode, where a travel control for the vehicle is performed at least partially automatically by way of automated driving, and a manual driving mode, where traveling of the vehicle is performed based on an operating device which is operated by a vehicle occupant, and an operation amount acquisition unit configured to acquire an operation amount by which the operating device is operated by the vehicle occupant. On the basis of the operation amount acquired by the operation amount acquisition unit when switching from the manual driving mode to the automated driving mode, the travel control processing unit sets a first O/R threshold value for the operation amount at a time of canceling at least a portion of the automated driving mode.

### CROSS-REFERENCE TO RELATED APPLICATION

This application is based upon and claims the benefit of priority from Japanese Patent Application No. 2016-245333 filed on Dec. 19, 2016, the contents of which are incorporated herein by reference.

### BACKGROUND OF THE INVENTION

### Field of the Invention

The present invention relates to a vehicle control device which carries out a travel control for a host vehicle at least partially by way of automated driving.

### Description of the Related Art

In Japanese Laid-Open Patent Publication No. 2008-132980, an object is of providing a vehicle driving operation assisting device, which enables a driver to easily perceive switching of a vehicle control mode.

In order to achieve such an object, according to Japanese Laid-Open Patent Publication No. 2008-132980, the vehicle driving operation assisting device is equipped with a travel control means adapted to control traveling of a host vehicle in accordance with either one of vehicle control modes of an automated control mode, in which the vehicle is made to follow a preceding vehicle, and a manual control mode, in which the vehicle travels independently corresponding to operations of the accelerator pedal, a mode switching means adapted to switch between the vehicle control modes, and a modifying means adapted to temporarily modify the vehicle characteristics into prescribed characteristics when the vehicle control mode is switched by the mode switching means.

### SUMMARY OF THE INVENTION

Incidentally, in the technique disclosed in Japanese Laid-Open Patent Publication No. 2008-132980, during travel assistance (automated driving), when an operated amount of an acceleration operation performed by a vehicle occupant exceeds a preset override threshold value, it is determined that an override operation has occurred, so that the switch to manual driving is made.

In this case, since the aforementioned override threshold value is a fixed value, and if the override threshold value is set to a low value, the operated amount in accordance with the acceleration operation easily exceeds the override threshold value, and consequently automated driving is canceled by merely performing a slight acceleration operation (for example, a mistaken operation or application of a load). Thus, there is a problem in that the intentions of the vehicle occupant are not met.

Conversely, if the override threshold value is set to a high value, since time is required until the operated amount in accordance with the acceleration operation exceeds the override threshold value, there is a concern that time may be spent in switching over from automated driving to manual driving, the operations of the vehicle occupant become cumbersome, and a problem results in that a sense of discomfort arises in terms of operability.

The present invention has been devised in view of the aforementioned problems, and has the object of providing a vehicle control device in which, by making the override threshold value variable, it is possible to solve both the problem of automated driving being canceled immediately, as well as the problem of automated driving not being canceled easily enough.

[1] A vehicle control device according to the present invention is equipped with a travel control processing unit configured to control traveling of a host vehicle in accordance with either one of an automated driving mode, in which a travel control for the host vehicle is performed at least partially automatically by way of automated driving, and a manual driving mode, in which traveling of the host vehicle is performed on the basis of an operating device which is operated by a vehicle occupant, and an operation amount acquisition unit configured to acquire an operation amount by which the operating device is operated by the vehicle occupant, wherein, on the basis of the operation amount, which was acquired by the operation amount acquisition unit when switching from the manual driving mode to the automated driving mode, the travel control processing unit sets a first threshold value for the operation amount at a time of canceling at least a portion of the automated driving mode.

In accordance with the vehicle control device, the threshold value (first threshold value) at which at least a portion of the automated driving mode is canceled is set on the basis of the operation amount of the vehicle occupant, and therefore, an appropriate threshold value can be set, and the automated driving mode can be executed, even under a condition in which the operating device is being operated. More specifically, by making the override threshold value variable, it is possible to solve both the problem of automated driving being canceled immediately, as well as the problem of automated driving not being canceled easily enough.

As used herein, the phrase “canceling at least a portion of the automated driving mode” includes the following cases.

(A) automated driving→manual driving without travel assistance, or manual driving a portion of which includes travel assistance; and

(B) partial automated driving in which a travel control is performed partially automatically→manual driving without travel assistance, or manual driving a portion of which includes travel assistance.

The operation amount of the operating device includes the following cases.

(i) If the target of operation is the accelerator pedal, the operation amount is at a minimum value when the accelerator pedal is in a natural state, and the operation amount increases due to an increase in the amount at which the accelerator pedal is depressed.

(ii) If the target of operation is the brake pedal, the operation amount is at a minimum value when the brake pedal is in a natural state, and the operation amount increases due to an increase in the amount at which the brake pedal is depressed.

(iii) If the target of operation is the steering wheel, the operation amount is at a minimum value when the steering wheel is in a neutral position, and the operation amount increases by the steering wheel being steered to the left or the right.

(iv) In the case that the steering operation is performed manually (including the case of an ACC (Adaptive Cruise Control)), a target vehicle speed adjusting switch may be provided as an operation target, which is installed on the steering wheel or the like. In this case, the operation amount increases by operation of a plus side switch (to increase the target vehicle speed) of the target vehicle speed adjusting switch, and the operation amount decreases by operation of a minus side switch (to decrease the target vehicle speed) of the target vehicle speed adjusting switch.

[2] In the present invention, the travel control processing unit may include a first threshold value setting unit configured to set a reference value on the basis of the operation amount, which was acquired by the operation amount acquisition unit when switching from the manual driving mode to the automated driving mode, and to set as the first threshold value a value which is greater than the operation amount, and a mode selecting unit configured to select the manual driving mode, in the case that at least the operation amount exceeds the first threshold value.

In accordance with this feature, for example, during the automated driving mode, switching over to the manual driving mode is implemented at a stage at which the operation amount has exceeded the first threshold value by the vehicle occupant increasing the operation amount while performing a driving operation (including a case of being greater than or equal to the first threshold value, or a case of being greater than the first threshold value).

More specifically, while the vehicle occupant performs the driving operation, it is possible to realize both the function of switching from manual driving to automated driving, as well as an override function of switching from automated driving to manual driving.

[3] In the present invention, the first threshold value setting unit may set the first threshold value by adding a predetermined amount to the reference value, and in the case that the operation amount falls below the current reference value during the automated driving mode, may set a new reference value on the basis of the operation amount.

When the override threshold value is fixed, as has been the case conventionally, a phenomenon occurs in which it is either too easy or too difficult for the override operation to be performed depending on the operation amount. Further, when overriding, it is necessary to execute the operation for overriding after having fixed the operation amount in advance in accordance with the driving operation, which leads to a problem in that operability is adversely affected.

In contrast thereto, in the present invention, during the automated driving mode, in the case that the operation amount of the driving operation falls below the reference value, which was set when switching over to the automated driving mode, a new reference value is set on the basis of the operation amount. In other words, the reference value is updated. When the reference value is updated, the first threshold value is also updated to the sum of the updated reference value and the predetermined amount.

Consequently, if the driving operation is operated by the predetermined amount or slightly greater than the predetermined amount, switching over to the manual driving mode is implemented. As a result, when the vehicle occupant wishes to transition to the manual driving mode, it is sufficient so long as the driving operation is always performed at the same operation amount, and thus, the override operation becomes easy to perform, and the commercial value thereof can be enhanced.

[4] In the present invention, during selection of the automated driving mode, the mode selecting unit may switch to the manual driving mode when the operation amount exceeds a second threshold value which is set to a value that is less than or equal to a maximum value.

When the automated driving mode is selected, if the operation amount of the driving operation is large, cases may occur in which the first threshold value is set to a value that exceeds the maximum value of the operation amount, or in which the first threshold value is set to a value close to the maximum value of the operation amount. In such cases, situations may occur in which overriding is not possible, or in which the level of difficulty in performing the override operation becomes high.

Thus, by setting the second threshold value to be less than or equal to the maximum value of the operation amount, even if the first threshold value is set to a value in excess of the maximum value of the operation amount, or is set to a value close to the maximum value of the operation amount, it is possible to cause an override to occur, and switching over to the manual driving mode can be effected at a point in time when the operation amount has exceeded the second threshold value. As a result, it is possible to prevent in advance a state in which overriding becomes impossible, or a state in which the level of difficulty in performing the override operation becomes high.

Moreover, the phrase, “a point in time when the operation amount has exceeded the second threshold value” implies a point in time at which the operation amount has exceeded the second threshold value, assuming that the second threshold value is less than the maximum value of the operation amount, as well as a point in time at which the operation amount has become the same as the second threshold value, assuming that the second threshold value is the same as the maximum value of the operation amount.

[5] In the present invention, in the case that a switching command is issued to switch from the manual driving mode to the automated driving mode, the mode selecting unit may maintain the manual driving mode when the first threshold value set by the first threshold value setting unit exceeds a maximum value of the operation amount, and the operation amount exceeds a second threshold value which is set to a value that is less than or equal to the maximum value.

When a switching operation to switch to automated driving has been performed, in the case that the operation amount is already large, and a margin (margin operation amount=maximum value Dmax−operation amount Dx) for implementing the override cannot be adopted, or is small, then in order to prevent a situation in which overriding is impossible, it is necessary to make the override occur at a value that is less than or equal to the maximum value. Thus, a situation is conceivable in which the automated driving mode is entered into momentarily, and the manual driving mode is switched to immediately thereafter. Such an occurrence may cause the vehicle occupant to experience a sense of discomfort.

Thus, when a switching command is issued to switch to the automated driving mode, by not switching to the automated driving mode, but instead maintaining the manual driving mode when the first threshold value exceeds the maximum value of the operation amount, and the operation amount exceeds the second threshold value that is set to a value less than or equal to the maximum value, it is possible to prevent the transition between the manual driving mode and the automated driving mode from being switched within a short time period, and an effect is achieved of mitigating the sense of discomfort experienced by the vehicle occupant.

In accordance with the vehicle control device according to the present invention, by making the override threshold value variable, it is possible to solve both the problem of automated driving being canceled immediately, as well as the problem of automated driving not being canceled easily enough.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a block diagram showing a configuration of a vehicle including a vehicle control device according to an embodiment of the present invention;

FIG. 2 is a block diagram showing an operating device, an operation amount acquisition unit, and a travel control processing unit;

FIG. 3A is a time chart showing an override determination 1 according to a comparative example;

FIG. 3B is a time chart showing an override determination 2 according to the comparative example;

FIG. 4 is a time chart showing an override determination 1 according to an exemplary embodiment 1;

FIG. 5 is a time chart showing an override determination 2 according to the exemplary embodiment 1;

FIG. 6 is a time chart showing an override determination 3A according to the exemplary embodiment 1;

FIG. 7 is a time chart showing an override determination 3B according to the exemplary embodiment 1;

FIG. 8 is a time chart showing an override determination 4 according to the exemplary embodiment 1;

FIG. 9 is a time chart showing an override determination according to an exemplary embodiment 2;

FIG. 10 is a flowchart (first part thereof) showing processing operations of the vehicle control device according to the present embodiment; and

FIG. 11 is a flowchart (second part thereof) showing processing operations of the vehicle control device according to the present embodiment.

### DESCRIPTION OF THE PREFERRED EMBODIMENTS

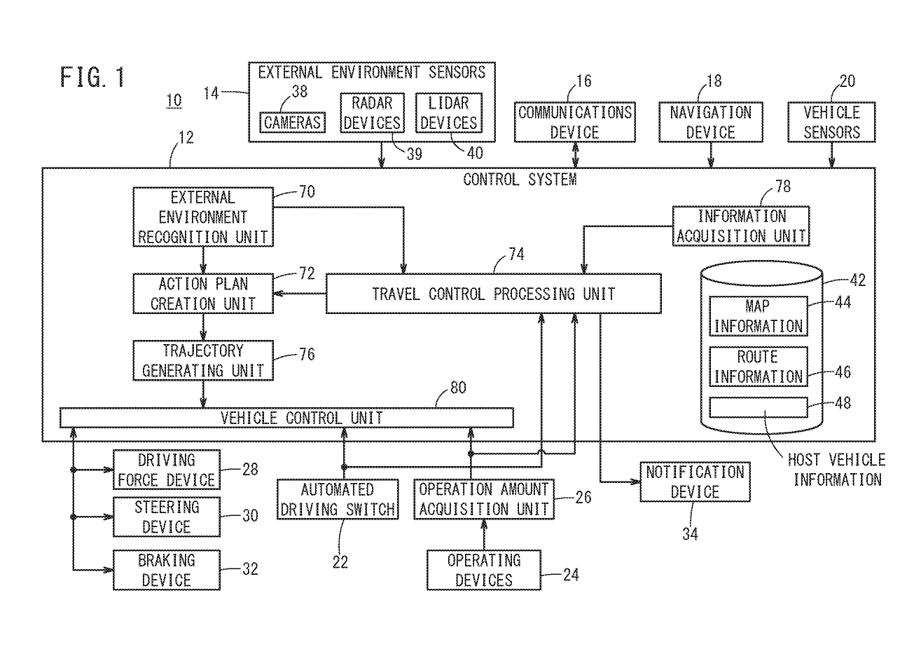

Exemplary embodiments of a vehicle control device according to the present invention will be presented and described in detail below with reference to FIGS. 1 through 11.

FIG. 1 is a block diagram showing a configuration of a vehicle control device 10 according to an embodiment of the present invention. The vehicle control device 10 is incorporated in a driver's own vehicle (hereinafter also referred to as a host vehicle), and performs a travel control for the vehicle by way of automated driving or manual driving. In this case, the term “automated driving” implies a concept that includes not only “fully automated driving” in which the travel control for the vehicle is performed entirely automatically, but also “partial automated driving” or “driving assistance” in which the travel control is partially performed automatically.

The vehicle control device 10 is basically made up from an input system device group, a control system 12, and an output system device group. The respective devices of the input system device group and the output system device group are connected via communication lines to the control system 12.

The input system device group includes external environment sensors 14, a communications device 16, a navigation device 18, vehicle sensors 20, an automated driving switch 22, and operation amount acquisition units 26 connected to operating devices 24.

The output system device group includes a driving force device 28 for driving the vehicle wheels (not shown), a steering device 30 for steering the vehicle wheels, a braking device 32 for braking the vehicle wheels, and a notification device 34 (notification unit) for notifying the driver primarily through visual and auditory sensation.

The external environment sensors 14 acquire information (hereinafter referred to as external environmental information) indicative of the state of the external environment around the vehicle, and output the acquired external environmental information to the control system 12. More specifically, the external environment sensors 14 are configured to include a plurality of cameras 38, a plurality of radar devices 39, and a plurality of LIDAR devices 40 (Light Detection and Ranging; Laser Imaging Detection and Ranging).

The communications device 16 is configured to be capable of communicating with external devices including roadside devices, other vehicles, and a server, and transmits and receives, for example, information related to transportation facilities, information related to other vehicles, probe information, or latest map information 44. The map information 44 is stored in a predetermined memory area of the storage device 42, or alternatively, in the navigation device 18.

The navigation device 18 is constituted to include a satellite positioning device, which is capable of detecting a current position of the vehicle, and a user interface (for example, a touch-panel display, a speaker, and a microphone). Based on the current position of the vehicle or a position designated by the user, the navigation device 18 calculates a route to a designated destination point, and outputs the route to the control system 12. The route calculated by the navigation device 18 is stored as planned travel route information 46 in a predetermined memory area of the storage device 42.

The vehicle sensors 20 output to the control system 12 detection signals from respective sensors, including a speed sensor for detecting the travel speed V (vehicle velocity), an acceleration sensor for detecting an acceleration, a lateral G sensor (lateral acceleration sensor) for detecting a lateral G force (a lateral acceleration), a yaw rate sensor for detecting an angular velocity about a vertical axis, an orientation sensor for detecting an orientation, and a gradient sensor for detecting a gradient of the vehicle. The detection signals are stored as host vehicle information 48 in a predetermined memory area of the storage device 42.

The automated driving switch 22, for example, is a pushbutton switch provided on the instrument panel. The automated driving switch 22 is configured to be capable of switching between a plurality of driving modes exhibiting differing degrees of automated driving, by manual operation thereof by a user including the driver.

The operating devices 24 include an accelerator pedal 50, a brake pedal 52, a steering wheel 54, a shift lever, a direction indication (turn signal) lever, and a target vehicle speed adjusting switch 56 which is disposed on the steering wheel 54 or the like.

The operation amount acquisition unit 26 acquires operation amounts that are made in accordance with operations (driving operations) of the vehicle occupant made with respect to the operating devices 24, and outputs the operation amounts to a later-described travel control processing unit 74.

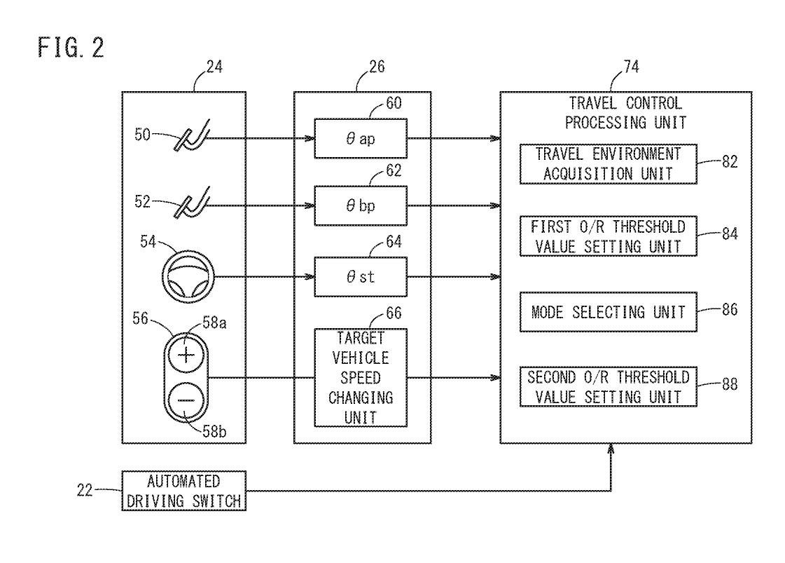

As shown in FIG. 2, as examples of the operating devices 24, there are the accelerator pedal 50, the brake pedal 52, the steering wheel 54, and the target vehicle speed adjusting switch 56. The target vehicle speed adjusting switch 56 is a switch for setting a target vehicle speed at which the host vehicle travels during an ACC (Adaptive Cruise Control) or during automated driving, and includes a plus side switch 58a and a minus side switch 58b.

Further, as shown in FIG. 2, as examples of the operation amount acquisition units 26, there are an accelerator pedal sensor 60, a brake pedal sensor 62, a steering angle sensor 64, and a target vehicle speed changing unit 66.

The accelerator pedal sensor 60 detects an operation amount θap [%] of the accelerator pedal 50. The operation amount θap is at a minimum value, for example, when the accelerator pedal 50 is in a natural state, and the operation amount θap increases due to an increase in the amount at which the accelerator pedal 50 is depressed.

The brake pedal sensor 62 detects an operation amount θbp [%] of the brake pedal 52. The operation amount θbp is at a minimum value, for example, when the brake pedal 52 is in a natural state, and the operation amount θbp increases due to an increase in the amount at which the brake pedal 52 is depressed.

The steering angle sensor 64 detects an operation amount (steering angle θst [deg]) of the steering wheel 54. The steering angle θst is at a minimum value when the steering wheel 54 is in a neutral position, and the steering angle θst increases by the steering wheel 54 being steered to the left or the right.

The target vehicle speed changing unit 66 increases the target vehicle speed, i.e., increases the operation amount, in accordance with an operation of the plus side switch 58a of the target vehicle speed adjusting switch 56, and decreases the target vehicle speed, i.e., decreases the operation amount, in accordance with an operation of the minus side switch 58b of the target vehicle speed adjusting switch 56.

The driving force device 28 is constituted from a driving force ECU (Electronic Control Unit), and a drive source including an engine and/or a driving motor. The driving force device 28 generates a travel driving force (torque) for the vehicle in accordance with vehicle control values input thereto from a described-later vehicle control unit 80, and transmits the travel driving force to the vehicle wheels directly or through a transmission.

The steering device 30 is constituted from an EPS (electric power steering system) ECU, and an EPS device. The steering device 30 changes the orientation of the wheels (steered wheels) in accordance with vehicle control values input thereto from the vehicle control unit 80.

The braking device 32, for example, is an electric servo brake used in combination with a hydraulic brake, and is made up from a brake ECU and a brake actuator. The braking device 32 brakes the vehicle wheels in accordance with vehicle control values input thereto from the vehicle control unit 80.

The notification device 34 is made up from a notification ECU, a display device, and an audio device. The notification device 34 carries out a notifying operation in relation to an automated driving mode or a manual driving mode or the like, in accordance with a notification command output from the control system 12.

The automated driving mode is a driving mode in which the host vehicle travels under the control of the control system 12, in a state in which the vehicle occupant does not operate the operating devices 24 (specifically, the accelerator pedal 50, the brake pedal 52, and the steering wheel 54, etc.). Stated otherwise, the automated driving mode is a driving mode in which the control system 12 controls a portion or all of the driving force device 28, the steering device 30, and the braking device 32 in accordance with sequentially created action plans.

When the vehicle occupant performs a predetermined operation using the operating devices 24 during implementation of the automated driving mode, the automated driving mode is canceled automatically, together with switching to a driving mode (which may include the manual driving mode) in which the level of driving automation is relatively low. Hereinafter, an operation in which the vehicle occupant operates the operating devices 24 in order to transition from automated driving to manual driving will also be referred to as an “override operation”.

The control system 12 is constituted by one or a plurality of ECUs, and comprises various function realizing units in addition to the aforementioned storage device 42. According to the present embodiment, the function realizing units are software-based functional units, in which the functions thereof are realized by one or a plurality of CPUs (central processing units) executing programs that are stored in the non-transitory storage device 42.

Alternatively, the function realizing units may be hardware-based functional units made up from integrated circuits such as field-programmable gate arrays (FPGA) or the like.

In addition to the storage device 42 and the vehicle control unit 80, the control system 12 is configured to include an external environment recognition unit 70, an action plan creation unit 72, a travel control processing unit 74, a trajectory generating unit 76, and an information acquisition unit 78.

Using various information input thereto from the input system device group (for example, external environmental information from the external environment sensors 14), the external environment recognition unit 70 recognizes lane markings (white lines) on both sides of the vehicle, and generates “static” external environment recognition information, including location information of stop lines and traffic signals, or travel enabled regions in which traveling is possible. Further, using the various information input thereto, the external environment recognition unit 70 generates “dynamic” external environment recognition information, including information concerning obstacles such as parked or stopped vehicles, traffic participants such as people and other vehicles, and the colors of traffic signals.

On the basis of recognition results from the external environment recognition unit 70, the action plan creation unit 72 creates action plans (a time series of events) for each of respective travel segments, and updates the action plans as needed. As types of events, for example, there may be cited events in relation to deceleration, acceleration, branching, merging, lane keeping, lane changing, passing other vehicles, and the aforementioned ACC, etc.

In this instance, “deceleration” and “acceleration” are events in which the vehicle is made to decelerate or accelerate. “Branching” and “merging” are events in which the vehicle is made to travel smoothly at a branching point or a merging point. “Lane changing” is an event in which the travel lane of the vehicle is made to change. “Passing” is an event in which the vehicle is made to overtake a preceding vehicle.

Further, “lane keeping” is an event in which the vehicle is made to travel without departing from the travel lane, and is subdivided based on a combination of travel modes. More specifically, as such travel modes, there may be included constant speed traveling, follow-on traveling, traveling while decelerating, traveling through a curve, or traveling to avoid obstacles. “ACC” is an event that performs an automated constant speed control for the vehicle, as well as adjustment of an inter-vehicle distance.

Using the map information 44, the planned travel route information 46, and the host vehicle information 48, which are read from the storage device 42, the trajectory generating unit 76 calculates and generates a travel trajectory (a time series of target behaviors) in accordance with the action plan created by the action plan creation unit 72. More specifically, the travel trajectory is a time series data set, in which the data units thereof are defined by a position, a posture angle, a velocity, an acceleration, a curvature, a yaw rate, and a steering angle.

The vehicle control unit 80 determines respective vehicle control values in order to control traveling of the vehicle, in accordance with the travel trajectory (time series of target behaviors) generated by the trajectory generating unit 76. In addition, the vehicle control unit 80 outputs the obtained vehicle control values, respectively, to the driving force device 28, the steering device 30, and the braking device 32.

The information acquisition unit 78 acquires information necessary for the process of determining conditions (hereinafter referred to as environmental conditions) in relation to the travel environment of the vehicle. As detailed examples of such necessary information, there may be cited time information (for example, the current time, the time zone, an expected arrival time), geographic information (for example, latitude, longitude, altitude, topography, differences in elevation), and weather information (for example, the weather, temperature, humidity, forecast information).

On the other hand, the travel control processing unit 74 controls traveling of the host vehicle by implementing either one of the automated driving mode, in which the travel control for the host vehicle is performed at least partially automatically by way of automated driving, and the manual driving mode, in which at least a portion of automated driving is carried out by a driving operation of the vehicle occupant performed with respect to at least one of the operating devices.

More specifically, as shown in FIG. 2, the travel control processing unit 74 functions as a travel environment acquisition unit 82, a first O/R threshold value setting unit 84 (first threshold value setting unit), a mode selecting unit 86, and a second O/R threshold value setting unit 88.

The travel environment acquisition unit 82 acquires information concerning the travel environment of the host vehicle. Within the travel environment, there are included the most recent recognition results by the external environment recognition unit 70, or acquired information (for example, the aforementioned time information, geographical information, and weather information) from the information acquisition unit 78.

In addition, for example, in the automated driving mode, a travel control is performed on the basis of the travel environment, etc., acquired by the travel environment acquisition unit 82, whereas in the manual driving mode, a travel control is performed on the basis of the travel environment, as well as the operation amounts, etc., from the operation amount acquisition units 26 which are based on operations of the operating devices 24 made by the vehicle occupant.

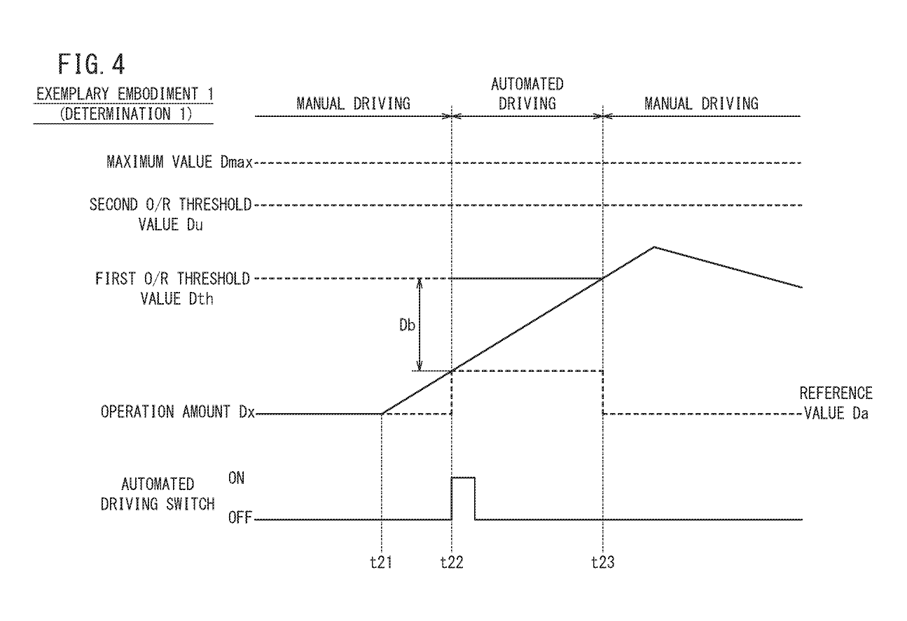

For example, as shown in FIG. 4, when switching from the manual driving mode to the automated driving mode, the first O/R threshold value setting unit 84 acquires a reference value Da on the basis of an operation amount Dx (for example, the operation amount θap of the accelerator pedal 50) that was acquired by the operation amount acquisition unit 26, and sets a value that is greater than the operation amount Dx as a manual driving mode selection threshold value (hereinafter referred to as a first O/R threshold value Dth). More specifically, a predetermined amount Db is added to the reference value Da to thereby set the first O/R threshold value Dth.

Further, in the case that the operation amount Dx falls below the current reference value Da during the automated driving mode, the first O/R threshold value setting unit 84 sets a new reference value Da (updates the reference value Da) on the basis of the operation amount Dx, and furthermore, sets the first O/R threshold value Dth (updates the first O/R threshold value Dth) by adding the predetermined amount Db to the new reference value Da.

In the case that at least the operation amount Dx exceeds the first O/R threshold value Dth, the mode selecting unit 86 selects the manual driving mode.

The second O/R threshold value setting unit 88 sets a threshold value for the operation amount Dx (referred to simply as a second O/R threshold value Du) at which switching from the automated driving mode to the manual driving mode is allowed. The threshold value is a value that is less than or equal to the maximum value of the operation amount Dx (hereinafter referred to as a maximum operation value Dmax).

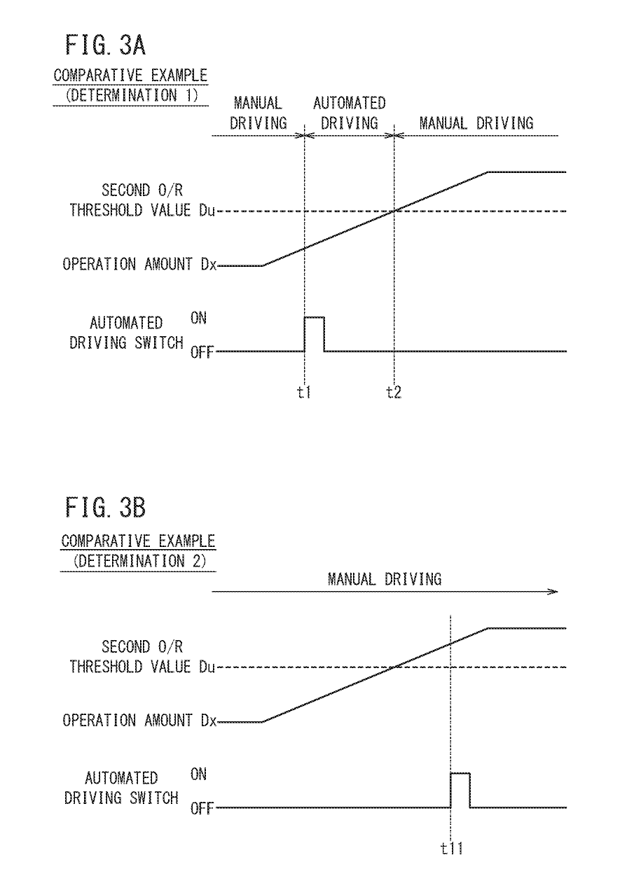

Override determinations made in accordance with a comparative example, an exemplary embodiment 1, and an exemplary embodiment 2 will now be described with reference to FIGS. 3A to 9.

### Determination 1 According to the Comparative Example

In the comparative example, as shown in FIG. 3A, when the vehicle occupant operates the automated driving switch 22, for example at time t1, during the period in which the operation amount Dx is less than or equal to the second O/R threshold value Du, switching is carried out from the manual driving mode to the automated driving mode. Thereafter, at time t2, when the operation amount Dx has exceeded the second O/R threshold value Du, switching from the automated driving mode back to the manual driving mode is implemented. The second O/R threshold value Du is a fixed value.

### Determination 2 According to the Comparative Example

However, as shown in FIG. 3B, even if the vehicle occupant operates the automated driving switch 22, for example at time t11, after the operation amount Dx has exceeded the second O/R threshold value Du, since the operation amount Dx is in excess of the second O/R threshold value Du, switching to the automated driving mode is not performed, and the manual driving mode is maintained.

In such a manner, in the comparative example, there is a problem in that, even if an attempt is made to transition into the automated driving mode by operating the automated driving switch 22 in a state in which the accelerator pedal is depressed to a certain extent, it is impossible to transition into the automated driving mode.

Provisionally, if the second O/R threshold value Du were set to a high value so as to lengthen the period during which the input operation of the automated driving switch 22 remains valid, then another problem results, in that overriding cannot be realized unless the vehicle occupant operates the accelerator pedal 50 in excess of the second O/R threshold value Dth, and it becomes complicated to operate the pedal manually.

Next, determinations made in accordance with exemplary embodiment 1 will be described with reference to FIGS. 4 to 8. In exemplary embodiment 1, determinations are indicated on the basis of the operation amount Dx (in this case, the operation amount θap), which is changed, for example, by the vehicle occupant operating the accelerator pedal 50. The operation amount Dx is at a minimum value when the accelerator pedal 50 is in a natural state, and the operation amount Dx increases due to an increase in the amount at which the accelerator pedal 50 is depressed.

### Determination 1 According to Exemplary Embodiment 1

First, as shown in FIG. 4, in determination 1 according to the exemplary embodiment 1, in the case that the host vehicle is traveling in the manual driving mode, by the vehicle occupant depressing the accelerator pedal 50, for example at time t21, the operation amount Dx (in this case, the operation amount θap) gradually increases. On the other hand, the second O/R threshold value setting unit 88 sets the second O/R threshold value Du of the operation amount Dx at which switching over from the automated driving mode to the manual driving mode is permitted.

The value Dmax shown in FIG. 4 indicates a maximum operation value. In this instance, the maximum operation value, for example, may be an operation amount when the vehicle occupant cannot physically press the accelerator pedal 50 any further, or alternatively, assuming that a sensor is provided which detects that the accelerator pedal 50 has been maximally depressed by the vehicle occupant, may be an operation amount at a point in time when a detection signal from such a sensor is input. The aforementioned second O/R threshold value Du is a value that is less than or equal to the maximum operation value Dmax.

In addition, at time t22, when the vehicle occupant has entered into the automated driving mode by turning on the automated driving switch 22, the first O/R threshold value setting unit 84 sets the reference value Da on the basis of the operation amount Dx that was acquired by the operation amount acquisition unit 26. In this case, the operation amount Dx at time t22 may be set as the reference value Da, or an operation amount in proximity to time t22, for example, the operation amount Dx occurring within a range of 100 msec from time t22, may be set as the reference value Da. Further, concerning the first O/R threshold value Dth, a value that is greater than the operation amount Dx is set as the first O/R threshold value Dth. For example, a predetermined amount Db is added to the reference value Da to thereby set the first O/R threshold value Dth. The predetermined amount Db may be a fixed value, or may be a variable value that varies, for example, in accordance with the vehicle speed or the like.

In addition, the mode selecting unit 86 switches over to the manual driving mode at time t23, when the operation amount Dx is greater than or equal to the first O/R threshold value Dth or has exceeded the first O/R threshold value Dth. In other words, the automated driving mode is stopped, and the mode is switched to the manual driving mode.

In determination 1, unlike the comparative example, at time t22 when the automated driving switch 22 is turned on, since the first O/R threshold value Dth can be set to a value that is greater than the operation amount Dx, a situation can be prevented in which it is impossible to switch to the automated driving mode. In addition, by appropriately setting the predetermined amount Db, it is possible for the first O/R threshold value Dth to be set to an appropriate operation amount, and therefore, the operation when switching to the manual driving mode (an operation to depress the accelerator pedal or the like) becomes easy to perform, and operability when effecting the override operation can be enhanced.

### Determination 2 According to Exemplary Embodiment 1

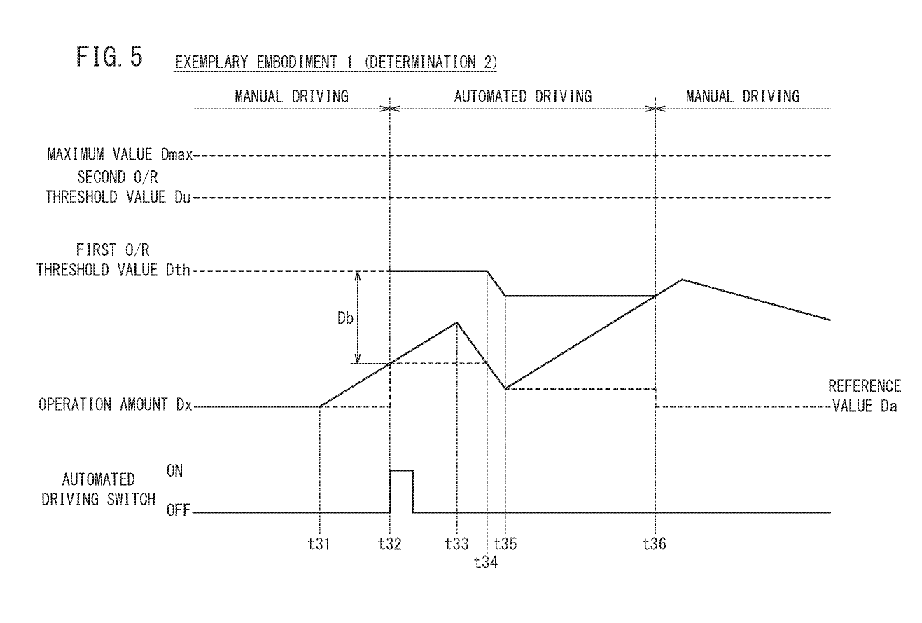

In determination 2 according to the exemplary embodiment 1, as shown in FIG. 5, for example, by the vehicle occupant starting to further press on the accelerator pedal 50 from time t31, and thereafter, at time t32, when the vehicle occupant has entered into the automated driving mode by operating the automated driving switch 22, the first O/R threshold value setting unit 84 acquires (sets) the reference value Da on the basis of the operation amount Dx that was acquired by the operation amount acquisition unit 26. Furthermore, the first O/R threshold value setting unit 84 adds the predetermined amount Db to the reference value Da to thereby set the first O/R threshold value Dth.

Thereafter, at time t33 or later, during the automated driving mode, for example, by the vehicle occupant reducing the increased pressing of the accelerator pedal 50, the operation amount Dx is gradually decreased. In addition, from time t34 when the operation amount Dx falls below the current reference value Da, a new reference value Da based on the operation amount Dx is acquired (set) (the reference value Da is updated).

The first O/R threshold value setting unit 84, upon updating the reference value Da, adds the predetermined amount Db to the new reference value Da to thereby acquire (set) the first O/R threshold value Dth (update the first O/R threshold value Dth).

By the vehicle occupant depressing the accelerator pedal 50 again, updating of the reference value Da is terminated at time t35 when the operation amount Dx starts to increase, and simultaneously therewith, updating of the first O/R threshold value Dth also is terminated. Although not shown, it is a matter of course that, at a stage at which the occupant once again reduces the increased amount at which the accelerator pedal 50 is pressed, and then the operation amount Dx gradually decreases, so that the operation amount Dx falls below the current reference value Da, updating of the reference value Da and updating of the first O/R threshold value Dth are resumed.

In addition, the mode selecting unit 86 switches over to the manual driving mode at time t36, when the operation amount Dx is greater than or equal to the first O/R threshold value Dth or has exceeded the first O/R threshold value Dth. In other words, the automated driving mode is stopped, and the mode is switched to the manual driving mode.

In determination 2, during the automated driving mode, in the case that the operation amount Dx of the driving operation falls below the reference value Da, which was set when switching over to the automated driving mode, a new reference value Da is set on the basis of the operation amount Dx. In other words, the reference value Da is updated. When the reference value Da is updated, the first O/R threshold value Dth is also updated to the sum of the updated reference value Da and the predetermined amount Db.

### Determination 3A and Determination 3B According to Exemplary Embodiment 1

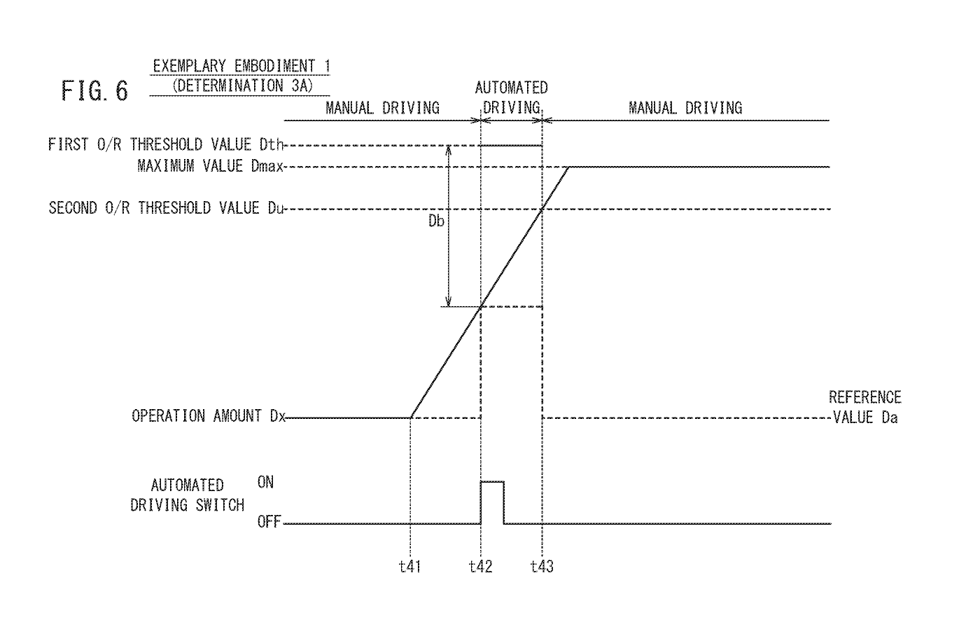

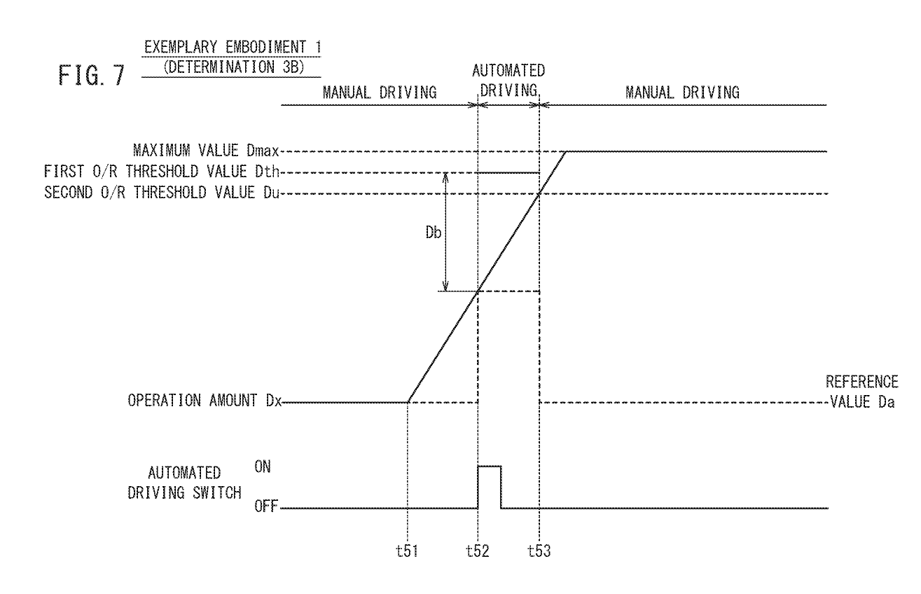

In determination 3A and determination 3B according to the exemplary embodiment 1, as shown in FIGS. 6 and 7, for example, by the vehicle occupant starting to further press on the accelerator pedal 50 from time t41 (time t51), and thereafter, at time t42 (time t52), when the vehicle occupant has entered into the automated driving mode by operating the automated driving switch 22, the first O/R threshold value setting unit 84 sets the reference value Da on the basis of the operation amount Dx that was acquired by the operation amount acquisition unit 26. Furthermore, the first O/R threshold value setting unit 84 adds the predetermined amount Db to the reference value Da to thereby set the first O/R threshold value Dth.

At this time, in some cases, the operation amount Dx at time t42 (time t52) is high, and as a result, the first O/R threshold value Dth may exceed the second O/R threshold value Du. FIG. 6 shows a case in which the first O/R threshold value Dth exceeds the maximum operation value Dmax, whereas FIG. 7 shows a case in which the first O/R threshold value Dth is greater than or equal to the second O/R threshold value Du and less than or equal to the maximum operation value Dmax. In the example of FIG. 6, the vehicle occupant cannot physically depress the accelerator pedal so as to become greater than the maximum operation value Dmax. In the example of FIG. 7, the occupant is required to operate the accelerator pedal to an operation amount that is near to the maximum operation value Dmax, and the level of difficulty in operating the accelerator pedal in order to switch over to manual driving becomes high. Thus, the mode selecting unit 86 switches over to the manual driving mode at time t43 (time t53), when the operation amount Dx is greater than or equal to the second O/R threshold value Du or has exceeded the second O/R threshold value Du during selection of the automated driving mode.

### Determination 4 According to Exemplary Embodiment 1

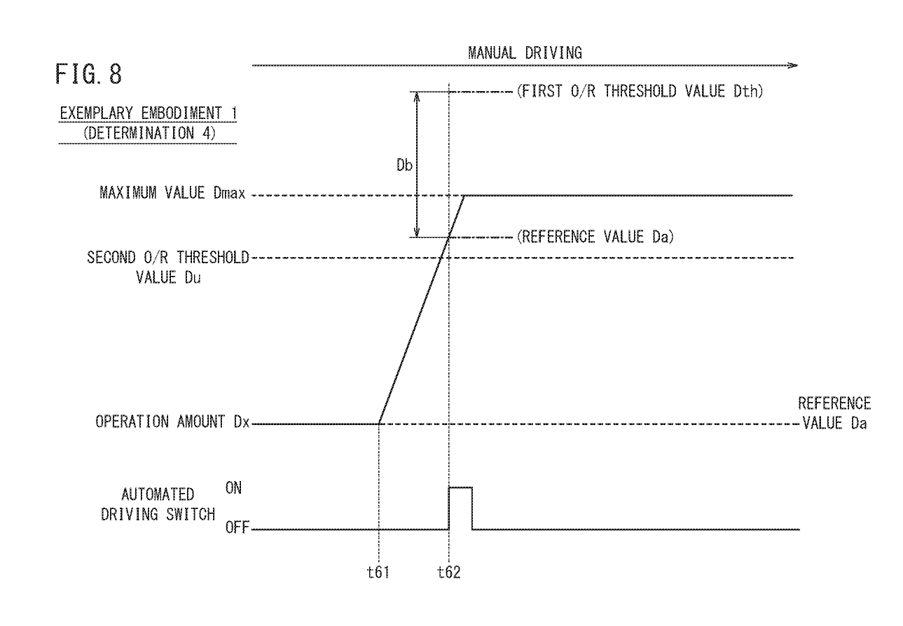

In determination 4 according to the exemplary embodiment 1, as shown in FIG. 8, for example, by the vehicle occupant starting to further press on the accelerator pedal 50 from time t61, and thereafter, at time t62, when the vehicle occupant has operated the automated driving switch 22, the first O/R threshold value setting unit 84 acquires (sets) the reference value Da on the basis of the operation amount Dx that was acquired by the operation amount acquisition unit 26 (refer to the two-dot-dashed line). Furthermore, the first O/R threshold value setting unit 84 adds the predetermined amount Db to the reference value Da to thereby set the first O/R threshold value Dth (refer to the two-dot-dashed line).

In some cases, the operation amount Dx at time t62 is high, and as a result, the first O/R threshold value Dth exceeds the maximum operation value Dmax, and the operation amount Dx exceeds the second O/R threshold value Du as well. In such cases, the mode selecting unit 86 maintains the manual driving mode without switching over to the automated driving mode.

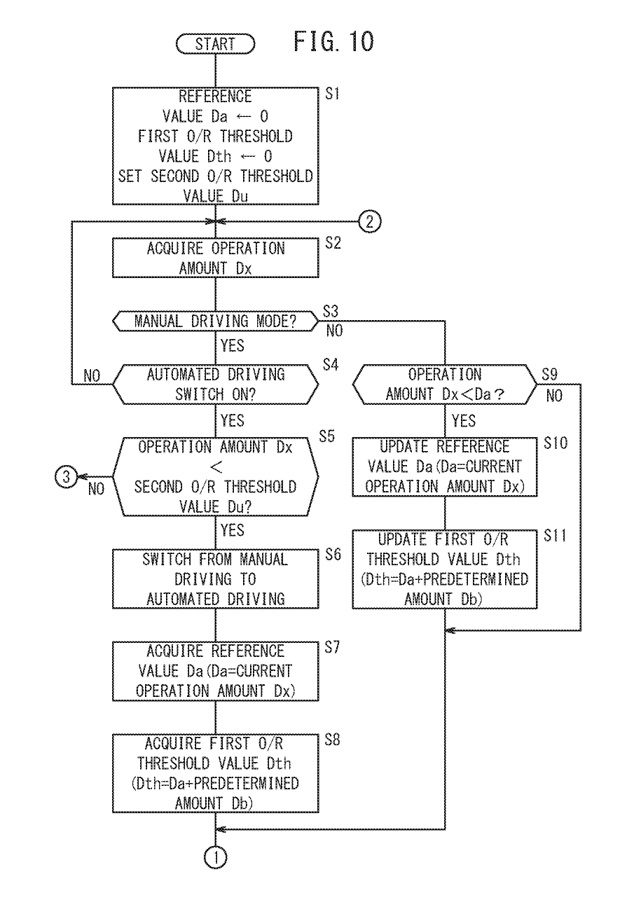

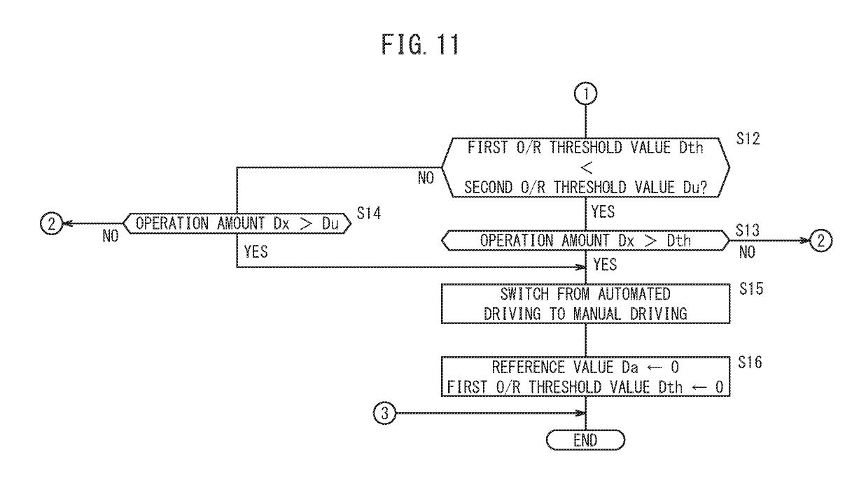

In the flowcharts of FIG. 10 and FIG. 11, as will be described later, in step S5, in the case that the operation amount Dx exceeds the second O/R threshold value Du, a determination is made to maintain the manual driving mode. Such a determination is made because, in the case that the operation amount Dx exceeds the second O/R threshold value Du, it is obvious that the first O/R threshold value Dth also exceeds the maximum operation value Dmax, and therefore, a step of acquiring the first O/R threshold value Dth such as step S8 or the like, and a step of comparing the first O/R threshold value Dth with the second O/R threshold value Du such as step S12 or the like can be omitted. Stated otherwise, in the case that the operation amount Dx exceeds the second O/R threshold value Du at a point in time when the automated driving switch 22 is turned ON, by setting the predetermined amount Db in advance so that the first O/R threshold value Dth is greater than or equal to the maximum operation value Dmax, the aforementioned step of acquiring the first O/R threshold value Dth, and the step of comparing the first O/R threshold value Dth with the second O/R threshold value Du can be omitted.

In the various determinations according to the above-described exemplary embodiment 1, determinations have primarily been described of implementing overriding based on operation of the accelerator pedal 50 by the vehicle occupant. However, the same considerations may be applied to operations of the brake pedal 52 or operations of the steering wheel 54 by the vehicle occupant.

### Determination According to the Exemplary Embodiment 2

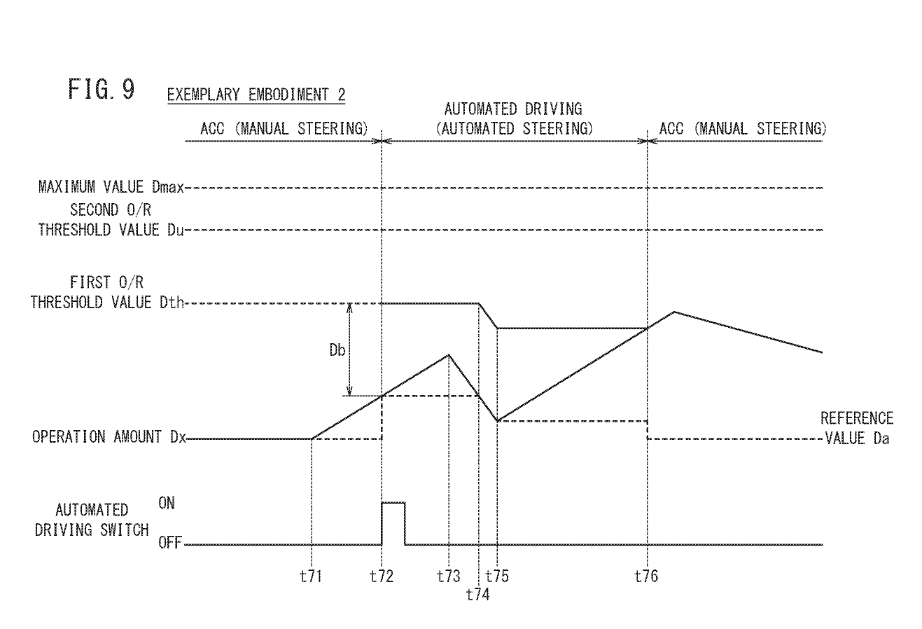

Next, a determination according to the exemplary embodiment 2, for example, a determination that is similar to determination 2 of the exemplary embodiment 1 (see FIG. 5), will be described with reference to FIG. 9.

The determination according to the exemplary embodiment 2 is performed on the basis of the operation amount Dx, which is changed, for example, by the vehicle occupant operating the target vehicle speed adjusting switch 56. In this case, the operation amount Dx increases by operation of the plus side switch 58a of the target vehicle speed adjusting switch 56 (increasing the target vehicle speed), and the operation amount Dx decreases by operation of the minus side switch 58b of the target vehicle speed adjusting switch (decreasing the target vehicle speed). In particular, the exemplary embodiment 2 shows switching from the manual driving mode (ACC), in which at least the steering operation is performed manually, to the automated driving mode (automated steering), in which the steering operation is performed automatically, and a determination of an override from the automated driving mode to the manual driving mode.

In addition, for example, at time t71 of FIG. 9, the vehicle occupant operates the plus side switch 58a of the target vehicle speed adjusting switch 56, whereby the operation amount Dx (target vehicle speed) gradually increases. At time t72, when the vehicle occupant has entered into the automated driving mode by operating the automated driving switch 22, the first O/R threshold value setting unit 84 sets the reference value Da on the basis of the operation amount Dx (target vehicle speed) that was acquired by the operation amount acquisition unit 26. Further, the first O/R threshold value setting unit 84 adds the predetermined amount Db to the reference value Da to thereby set the first O/R threshold value Dth.

Thereafter, for example, after time t73 during the automated driving mode, by the occupant operating the minus side switch 58b of the target vehicle speed adjusting switch 56, the operation amount Dx gradually decreases, and from time t74 when the operation amount Dx falls below the current reference value Da, a new reference value Da based on the operation amount Dx is set (the reference value Da is updated). Further, the first O/R threshold value setting unit 84, upon updating the reference value Da, adds the predetermined amount Db to the new reference value Da to thereby set the first O/R threshold value Dth (update the first O/R threshold value Dth).

By the vehicle occupant operating the plus side switch 58a again, updating of the reference value Da is terminated at time t75 when the operation amount Dx begins increasing, and simultaneously therewith, updating of the first O/R threshold value Dth also is terminated.

In addition, the mode selecting unit 86 switches over to the manual driving mode at time t76, when the operation amount Dx is greater than or equal to the first O/R threshold value Dth or has exceeded the first O/R threshold value Dth. In other words, the automated driving mode is stopped, and the mode is switched to the manual driving mode.

In the above-described example, the automated driving mode is switched over to the manual driving mode (ACC) in accordance with the operation amount Dx of the plus side switch 58a of the target vehicle speed adjusting switch 56. However, aside from this feature, switching over to the manual driving mode (ACC) may take place in accordance with a duration over which the plus side switch 58a is pressed, or in accordance with an amount of change in the target vehicle speed per a predetermined time.

Moreover, in exemplary embodiment 2 as well, it is a matter of course that the same determinations as those of determination 1, determination 3A, determination 3B, and determination 4 of the exemplary embodiment 1 are carried out.

Next, processing operations of the vehicle control device 10 according to the present embodiment will be described with reference to the flowcharts of FIGS. 10 and 11.

First, in step S1, the first O/R threshold value setting unit 84 initializes the reference value Da and the first O/R threshold value Dth to zero. Further, the second O/R threshold value setting unit 88 sets the second O/R threshold value Du.

Thereafter, in step S2, the travel control processing unit 74 acquires an operation amount Dx (for example, the operation amount θap of the accelerator pedal 50) from the operation amount acquisition unit 26.

In step S3, the mode selecting unit 86 determines whether or not the current driving mode is the manual driving mode. If the current driving mode is the manual driving mode (step S3: YES), the process proceeds to the next step S4, and the travel control processing unit 74 determines whether or not an operation has been made to turn ON the automated driving switch 22. If the operation to turn ON the automated driving switch 22 is not made (step S4: NO), the process returns to step S2, and step S2 and the steps subsequent thereto are repeated.

At a stage at which the automated driving switch 22 is turned ON (S4: YES), the process proceeds to the following step S5, whereupon the mode selecting unit 86 determines whether or not the operation amount Dx is less than the second O/R threshold value Du. If the operation amount Dx is less than the second O/R threshold value Du (step S5: YES), the process proceeds to step S6, whereupon the mode selecting unit 86 switches to the automated driving mode.

In step S7, the first O/R threshold value setting unit 84 acquires the reference value Da, based on the operation amount Dx. For example, the operation amount Dx is set as the reference value Da.

In step S8, the first O/R threshold value setting unit 84 acquires the first O/R threshold value Dth. Of course, a value that is greater than the operation amount Dx is set as the first O/R threshold value Dth. For example, the predetermined amount Db is added to the reference value Da to thereby set the first O/R threshold value Dth.

On the other hand, in the case it was determined in step S3 that the vehicle is currently in the automated driving mode (step S3: NO), the process proceeds to step S9, and the first O/R threshold value setting unit 84 determines whether or not the operated amount Dx is less than the reference value Da. If the operation amount Dx is less than the reference value Da (step S9: YES), the process proceeds to step S10, and the first O/R threshold value setting unit 84 acquires the reference value Da based on the current operation amount Dx. That is, the current operation amount Dx is set as the reference value Da. Consequently, the reference value Da is updated (determination 2 according to the exemplary embodiment 1, see FIG. 5).

Thereafter, in step S11, the first O/R threshold value setting unit 84 acquires the first O/R threshold value Dth. Of course, a value that is greater than the operation amount Dx is set as the first O/R threshold value Dth. For example, the predetermined amount Db is added to the reference value Da to thereby set the first O/R threshold value Dth. Consequently, the first O/R threshold value Dth is updated (determination 2 according to the exemplary embodiment 1, see FIG. 5).

At a stage following completion of the above-described process of step S8 or step S11, or in the above-described step S9, if it is determined that the operation amount Dx is not less than the reference value Da (step S9: NO), the process proceeds to step S12 of FIG. 11, and the mode selecting unit 86 determines whether or not the first O/R threshold value Dth is less than the second O/R threshold value Du. If the first O/R threshold value Dth is less than the second O/R threshold value Du (step S12: YES), the process proceeds to the following step S13, whereupon the mode selecting unit 86 determines whether or not the operation amount Dx is in excess of the first O/R threshold value Dth. If the operation amount Dx exceeds the first O/R threshold value Dth (step S13: YES), the process proceeds to step S15, whereupon the mode selecting unit 86 switches to the manual driving mode (determination 1 of exemplary embodiment 1, see FIG. 4). Thereafter, the process proceeds to step S16, and the reference value Da and the first O/R threshold value Dth are initialized to zero.

On the other hand, in step S12, if the first O/R threshold value Dth is greater than or equal to the second O/R threshold value Du (step S12: NO), the process proceeds to the following step S14, whereupon the mode selecting unit 86 determines whether or not the operation amount Dx is in excess of the second O/R threshold value Du. If the operation amount Dx exceeds the second O/R threshold value Du (step S14: YES), the process proceeds to step S15, whereupon the mode selecting unit 86 switches to the manual driving mode (determinations 3A and 3B of exemplary embodiment 1, see FIGS. 6 and 7). Thereafter, the process proceeds to step S16, and the reference value Da and the first O/R threshold value Dth are initialized to zero.

In the case it is determined in the above-described step S13 that the operation amount Dx is less than or equal to the first O/R threshold value Dth (step S13: NO), or in the case it is determined in the above-described step S14 that the operation amount Dx is less than or equal to the second O/R threshold value Du (step S14: NO), the process returns to step S2 of FIG. 10, and step S2 and the steps subsequent thereto are repeated.

Further, in the case it is determined in step S5 that the operation amount Dx is greater than or equal to the second O/R threshold value Du (step S5: NO), the mode selecting unit 86 maintains the manual driving mode (determination 4 in accordance with the exemplary embodiment 1, see FIG. 8).

As has been described above, the vehicle control device 10 according to the present embodiment is equipped with the travel control processing unit 74 that controls traveling of the host vehicle in accordance with either one of the automated driving mode, in which a travel control for the host vehicle is performed at least partially automatically by way of automated driving, and the manual driving mode, in which traveling of the host vehicle is performed on the basis of an operating device 24 which is operated by the vehicle occupant, and the operation amount acquisition unit 26 which acquires the operation amount Dx at which the operating device 24 is operated by the vehicle occupant.

In addition, on the basis of the operation amount Dx that was acquired by the operation amount acquisition unit 26 when switching from the manual driving mode to the automated driving mode, the travel control processing unit 74 sets the first O/R threshold value Dth for the operation amount Dx at the time of canceling at least a portion of the automated driving mode.

In accordance with this feature, the threshold value (first O/R threshold value Dth) at which at least a portion of the automated driving mode is canceled is set on the basis of the operation amount of the vehicle occupant, and therefore, an appropriate threshold value can be set, and the automated driving mode can be executed, even under a condition in which the operating device 24 is being operated. More specifically, by making the override threshold value variable, it is possible to solve both the problem of automated driving being canceled immediately, as well as the problem of automated driving not being canceled easily enough.

Further, in the present embodiment, the travel control processing unit 74 includes the first O/R threshold value setting unit 84 that sets the reference value Da on the basis of the operation amount Dx that was acquired by the operation amount acquisition unit 26 when switching from the manual driving mode to the automated driving mode, and which sets as the first O/R threshold value Dth a value that is greater than the operation amount Dx, and the mode selecting unit 86 which selects the manual driving mode, in the case that at least the operation amount Dx exceeds the first O/R threshold value Dth.

In accordance with this feature, for example, during the automated driving mode, switching over to the manual driving mode is implemented at a stage at which the operation amount Dx has exceeded the first O/R threshold value Dth by the vehicle occupant increasing the operation amount Dx while performing a driving operation (including a case of being greater than or equal to the first O/R threshold value Dth, or a case of being greater than the first O/R threshold value Dth).

More specifically, while the vehicle occupant performs the driving operation, it is possible to realize both the function of switching from manual driving to automated driving, as well as an override function of switching from automated driving to manual driving.

Further, in the present embodiment, the first O/R threshold value setting unit 84 sets the first O/R threshold value Dth by adding the predetermined amount Db to the reference value Da, and in the case that the operation amount Dx falls below the current reference value Da during the automated driving mode, sets a new reference value Da on the basis of the operation amount Dx.

When the override threshold value is fixed, as has been the case conventionally, a phenomenon occurs in which it is either too easy or too difficult for the override operation to be performed depending on the operation amount Dx. Further, when overriding, it is necessary to execute the operation for overriding after having fixed the operation amount Dx in advance in accordance with the driving operation, which leads to a problem in that operability is adversely affected.

In contrast thereto, in the present embodiment, during the automated driving mode, in the case that the operation amount Dx falls below the reference value Da, which was set when switching over to the automated driving mode, a new reference value Da is set on the basis of the operation amount Dx. In other words, the reference value Da is updated. When the reference value Da is updated, the first O/R threshold value Dth is also updated to the sum of the updated reference value Da and the predetermined amount Db.

Consequently, if the operation of the operating device 24 is performed by the predetermined amount Db or slightly greater than the predetermined amount Db, switching over to the manual driving mode is implemented. As a result, when the vehicle occupant wishes to transition to the manual driving mode, it is sufficient so long as the driving operation is always performed at the same operation amount Dx, and thus, the override operation becomes easy to perform, and the commercial value thereof can be enhanced.

In the present embodiment, during selection of the automated driving mode, the mode selecting unit 86 switches to the manual driving mode when the operation amount Dx exceeds the second O/R threshold value Du which is set to a value that is less than or equal to the maximum operation value Dmax.

When the automated driving mode is selected, if the operation amount of the driving operation is large, cases may occur in which the first O/R threshold value Dth is set to a value that exceeds the maximum operation value Dmax, or in which the first O/R threshold value Dth is set to a value close to the maximum operation value Dmax. In such cases, situations may occur in which overriding is not possible, or in which the level of difficulty in performing the override operation becomes high.

Thus, by setting the second O/R threshold value Du to be less than or equal to the maximum operation value Dmax, even if the first O/R threshold value Dth is set to a value in excess of the maximum operation value Dmax, or is set to a value close to the maximum operation value Dmax, it is possible to cause an override to occur, and switching over to the manual driving mode can be effected at a point in time when the operation amount Dx has exceeded the second O/R threshold value Du. As a result, it is possible to prevent in advance a state in which overriding becomes impossible, or a state in which the level of difficulty in performing the override operation becomes high.

Moreover, the phrase, “a point in time when the operation amount Dx has exceeded the second O/R threshold value Du” implies a point in time at which the operation amount Dx has exceeded the second O/R threshold value Du, assuming that the second O/R threshold value Du is less than the maximum operation value Dmax, as well as a point in time at which the operation amount Dx has become the same as the second O/R threshold value Du, assuming that the second O/R threshold value Du is the same as the maximum operation value Dmax.

In the present embodiment, in the case that a switching command is issued to switch from the manual driving mode to the automated driving mode, the mode selecting unit 86 maintains the manual driving mode when the first O/R threshold value Dth set by the first O/R threshold value setting unit 84 exceeds the maximum operation value Dmax of the operation amount Dx, and the operation amount Dx exceeds the second O/R threshold value Du which is set to a value that is less than or equal to the maximum operation value Dmax.

When a switching operation to switch to automated driving has been performed, in the case that the operation amount Dx is already large, and a margin (margin operation amount=maximum operation value Dmax−operation amount Dx) for implementing the override cannot be adopted, or is small, then in order to prevent a situation in which overriding is impossible, it is necessary to make the override occur at a value that is less than or equal to the maximum operation value Dmax. Thus, a situation is conceivable in which the automated driving mode is entered into momentarily, and the manual driving mode is switched to immediately thereafter. Such an occurrence may cause the vehicle occupant to experience a sense of discomfort.

Thus, when a switching command is issued to switch to the automated driving mode, by not switching to the automated driving mode, but instead maintaining the manual driving mode when the first O/R threshold value Dth exceeds the maximum operation value Dmax of the operation amount Dx, and the operation amount exceeds the second O/R threshold value Du that is set to a value less than or equal to the maximum operation value Dmax, it is possible to prevent the transition between the manual driving mode and the automated driving mode from being switched within a short time period, and an effect is achieved of mitigating the sense of discomfort experienced by the vehicle occupant.

The present invention is not limited to the embodiments described above, and it goes without saying that the present invention can be freely modified within a range that does not depart from the scope of the present invention.

For example, in the above-described embodiments, in the case that a plurality of operation devices 24 are operated during the automated driving mode, for example, in the case that not only operation of the accelerator pedal 50, but also operation of the brake pedal 52 and the steering wheel 54 are carried out, either one of the first O/R threshold value Dth and the second O/R threshold value Du may be lowered in value. Owing to this feature, it becomes easier for the vehicle to transition from the automated driving mode to the manual driving mode. In other words, it becomes easier to override the automated driving mode.

Further, for example, in the above-described embodiments, in an operation made with respect to the accelerator pedal 50 or the like during the automated driving mode, for example, in the case that the speed of operation is greater than a certain fixed speed, either one of the first O/R threshold value Dth and the second O/R threshold value Du may be lowered in value. Owing to this feature, it becomes easier for the vehicle to transition from the automated driving mode to the manual driving mode. In other words, it becomes easier to override the automated driving mode.

Further, in the above-described embodiments, for example, in the determination 3B of the exemplary embodiment 1 shown in FIG. 7, if the first O/R threshold value Dth at time t52 when switching to the automated driving mode is less than or equal to the maximum operation value Dmax, then even if the relationship first O/R threshold value Dth>second O/R threshold value Du holds true, switching over to the manual driving mode may be carried out when the operation amount Dx exceeds the first O/R threshold value Dth.

What is claimed is:

1. A vehicle control device comprising:
a travel control processing unit configured to control traveling of a host vehicle in accordance with either one of an automated driving mode, in which a travel control for the host vehicle is performed at least partially automatically by way of automated driving, and a manual driving mode, in which traveling of the host vehicle is performed based on an operating device which is operated by a vehicle occupant; and
an operation amount acquisition unit configured to acquire an operation amount by which the operating device is operated by the vehicle occupant;
wherein, based on the operation amount, which was acquired by the operation amount acquisition unit when switching from the manual driving mode to the automated driving mode, the travel control processing unit sets a first threshold value for the operation amount at a time of canceling at least a portion of the automated driving mode.

2. The vehicle control device according to claim 1, wherein the travel control processing unit includes:
a first threshold value setting unit configured to set a reference value based on the operation amount, which was acquired by the operation amount acquisition unit when switching from the manual driving mode to the automated driving mode, and to set as the first threshold value a value which is greater than the operation amount; and
a mode selecting unit configured to select the manual driving mode, in a case that at least the operation amount exceeds the first threshold value.

3. The vehicle control device according to claim 2, wherein the first threshold value setting unit sets the first threshold value by adding a predetermined amount to the reference value, and in a case that the operation amount falls below the reference value at present during the automated driving mode, sets a new reference value based on the operation amount.

4. The vehicle control device according to claim 2, wherein during selection of the automated driving mode, the mode selecting unit switches to the manual driving mode when the operation amount exceeds a second threshold value which is set to a value that is less than or equal to a maximum value.

5. The vehicle control device according to claim 2, wherein, in a case that a switching command is issued to switch from the manual driving mode to the automated driving mode, the mode selecting unit maintains the manual driving mode when the first threshold value set by the first threshold value setting unit exceeds a maximum value of the operation amount, and the operation amount exceeds a second threshold value which is set to a value that is less than or equal to the maximum value.
